(19) United States
(12) Patent Application Publication
(10) Pub. No.: US 2013/0207931 A1
(43) Pub. Date: Aug. 15, 2013

(54) ELECTROSTATIC CAPACITIVE INPUT DEVICE

(71) Applicant: Alps Electric Co., Ltd., (US)

(72) Inventors: Hiroshi SHIGETAKA, Miyagi-ken (JP); Hiroaki TAKAHASHI, Miyagi-ken (JP)

(73) Assignee: ALPS ELECTRIC CO., LTD., Tokyo (JP)

(21) Appl. No.: 13/762,226

(22) Filed: Feb. 7, 2013

(30) Foreign Application Priority Data
Feb. 14, 2012 (JP) 2012-029370

(51) Int. Cl. G06F 3/044

(52) U.S. Cl. CPC G06F 3/044
USPC 345/174

(57) ABSTRACT

An electrostatic capacitive input device includes: an operation member having an operation surface on which an operator can perform an input operation; a sensor member which has a detection surface detecting a capacitance value corresponding to the input operation on the operation surface and is capable of outputting a detection signal corresponding to the detected capacitance value; and a control unit controlling an electronic apparatus based on the detection signal. The operation member and the sensor member are arranged such that a surface reverse to a surface including the operation surface faces the detection surface. The operation member is mounted on a cover member such that the operation surface is exposed from an outer surface of the cover member, and is separable from the sensor member together with the cover member. The sensor member is arranged in a housing in a state of being separated from the operation member.

### CLAIM OF PRIORITY

This application claims benefit of Japanese Patent Application No. 2012-029370 filed on Feb. 14, 2012, which is hereby incorporated by reference.

### BACKGROUND OF THE INVENTION

1. Field of the Invention

The present invention relates to an electrostatic capacitive input device, and particularly relates to an electrostatic capacitive input device which, when used as an input device of an electronic apparatus such as a laptop type personal computer (hereinafter, referred to as laptop personal computer) or a mobile phone, allows, for example, a cover panel of a keyboard portion of the laptop personal computer to easily be replaced without impairing the function of the input device.

2. Description of the Related Art

In a laptop personal computer, for example, an electrostatic capacitive input device called a touch pad is provided and used for an input of an operation such as for movement of a cursor or scroll of a screen. In recent years, there have been needs that a laptop personal computer user desires to replace a cover panel or the like of a keyboard portion or a palm rest portion of a laptop personal computer with one having a favorite design by themselves. According to such needs, an electrostatic capacitive input device which allows a cover panel to easily be replaced by a user themselves without impairing the function of the input device is desired.

As an existing electrostatic capacitive input device, an electrostatic capacitive input device disclosed in Japanese Patent No. 4163054 is known.

Hereinafter, the electrostatic capacitive input device disclosed in Japanese Patent No. 4163054 will be described with reference to FIG. 8. FIG. 8 is a diagram showing the electrostatic capacitive input device PD1 disclosed in Japanese Patent No. 4163054.

In the electrostatic capacitive input device PD1 disclosed in Japanese Patent No. 4163054, as shown in FIG. 8, a Y electrode layer EY is formed on a surface of a film substrate FB which is formed by connecting a first film substrate fb1 and a second film substrate fb2 via a folded portion BE and is made of a synthetic resin having insulating properties, and an insulating film IN made of an insulating resin is formed so as to be laminated on the Y electrode layer EY In addition, the film substrate FB is folded at the folded portion BE, and a back surface of the first film substrate fb1 and a back surface of the second film substrate fb2 are adhered to each other by means of a pressure sensitive adhesive or the like.

An X electrode layer EX is provided so as to be laminated on the insulating film IN provided on the first film substrate fb1, and a surface sheet FS which is operated from the outside is adhered to the X electrode layer EX by means of an adhesive or the like. When an operation is performed by touching the surface sheet FS, varying capacitances of the X electrode layer EX and the Y electrode layer EY are detected, and it is determined which operation is performed, whereby an input is possible in the input device. When the electrostatic capacitive input device PD1 is mounted in an electronic apparatus such as a laptop personal computer, the electrostatic capacitive input device PD1 is attached directly to a cover panel side of the electronic apparatus in a state where the surface sheet FS is exposed from the cover panel of the electronic apparatus.

However, the electrostatic capacitive input device PD1 is attached directly to the cover panel side of the electronic apparatus on which the electrostatic capacitive input device PD1 is mounted. Thus, when the user replaces the cover panel CP as they like, the electrostatic capacitive input device PD1 is removed together with the cover panel CP and the function of the input device is impaired.

### SUMMARY OF THE INVENTION

The present invention solves the above problems and provides an electrostatic capacitive input device which, when used as an input device of an electronic apparatus, allows, for example, a cover panel of a keyboard portion or a palm rest portion of a laptop personal computer to easily be replaced without impairing the function of the input device.

According to a first aspect, an electrostatic capacitive input device is mounted on an electronic apparatus including a cover member covering a housing, and includes: an operation member having an operation surface on which an operator can perform an input operation; a sensor member having a detection surface detecting a capacitance value corresponding to the input operation on the operation surface, the sensor member being capable of outputting a detection signal corresponding to the detected capacitance value; and a control unit controlling the electronic apparatus on the basis of the detection signal. A surface reverse to a surface including the operation surface of the operation member and the detection surface of the sensor member are located so as to face each other, the operation member is mounted on the cover member of the electronic apparatus such that the operation surface is exposed from an outer surface of the cover member, the sensor member is arranged in the housing in a state of being separated from the operation member, and the operation member is separable from the sensor member together with the cover member.

According to a second aspect, in the electrostatic capacitive input device, the sensor member may include an overlay member provided so as to be laminated on the detection surface, and the overlay member and the operation member may be separated from each other.

According to a third aspect, the electrostatic capacitive input device may further include a flexible member having flexibility, the flexible member being provided between the overlay member and the operation member, the flexible member being in contact with the overlay member and the operation member.

According to a fourth aspect, the electrostatic capacitive input device may further include a flexible member having flexibility, the flexible member being provided between the sensor member and the operation member, the flexible member being in contact with the sensor member and the operation member.

According to a fifth aspect, in the electrostatic capacitive input device, a thickness dimension of the overlay member may be uniform.

According to a sixth aspect, in the electrostatic capacitive input device, the flexible member may be formed from a gel-like material.

According to the first aspect, since the operation member is separable from the sensor member together with the cover member of the electronic apparatus, an effect is provided that an electrostatic capacitive input device can be provided which makes it possible for a user to replace a cover member originally provided in an electronic apparatus, for example, a cover panel of a keyboard portion of a laptop personal computer, with, for example, a cover member of a favorite design on which another operation member is mounted, by themselves without impairing the function of the electrostatic capacitive input device, after the electrostatic capacitive input device is incorporated into the electronic apparatus.

According to the second aspect, the capacitance value is likely to vary within a layer of air due to influence from the outside, but since the overlay member is arranged so as to be laminated on the detection surface, a layer of air between the operation member and the detection surface is small and the capacitance value is unlikely to be influenced within the overlay member by the outside. Thus, an effect is provided that variation of the capacitance value by influence from the outside is small and a more stable input operation is possible.

According to the third aspect, since the flexible member having flexibility is arranged between the overlay member and the operation member so as to be in contact with the overlay member and the operation member, there is no layer of air between the overlay member and the operation member, and the flexible member deforms to follow bending or the like of the operation member by an input operation. Thus, an excessive pressing force is not transmitted to the sensor member. Therefore, an effect is provided that the operability is not deteriorated and a more stable input operation is possible.

According to the fourth aspect, since the flexible member having flexibility is arranged between the sensor member and the operation member so as to be in contact with the sensor member and the operation member, there is no layer of air between the sensor member and the operation member, and the flexible member deforms to follow bending or the like of the operation member by an input operation. Thus, an excessive pressing force is not transmitted to the sensor member. Therefore, an effect is provided that the operability is not deteriorated and a more stable input operation is possible.

According to the fifth aspect, since the thickness dimension of the overlay member is made uniform, an effect is provided that variation of the thickness dimension of a layer of air between the operation member and the overlay member due to difference in an operation position is small and a more stable input operation is possible.

According to the sixth aspect, since the flexible member is formed from a gel-like material, the flexible member has adhesiveness. Due to the adhesiveness, the flexible member is retained and can easily be peeled off. Thus, an effect is provided that separation of the operation member is not disturbed.

### BRIEF DESCRIPTION OF THE DRAWINGS

FIG. 1 is a diagram showing an electrostatic capacitive input device according to a first embodiment;

FIG. 2 is a diagram showing a state where a cover member of an electronic apparatus is separated from a housing of the electronic apparatus;

FIG. 3 is a schematic diagram showing a capacitance generated when an operation body comes close to a sensor member;

FIG. 4 is a diagram showing an electrostatic capacitive input device according to a second embodiment;

FIG. 5 is a diagram showing an electrostatic capacitive input device according to a third embodiment;

FIG. 6 is a graph showing difference in variation of output by difference in the thickness dimension of an overlay member;

FIGS. 7A to 7C are diagrams showing a state where a cover member is replaced with a cover member of a different design; and

FIG. 8 is a diagram showing an electrostatic capacitive input device disclosed in Japanese Patent No. 4163054.

### DESCRIPTION OF THE PREFERRED EMBODIMENTS

### First Embodiment

Hereinafter, an electrostatic capacitive input device 100 according to a first embodiment will be described.

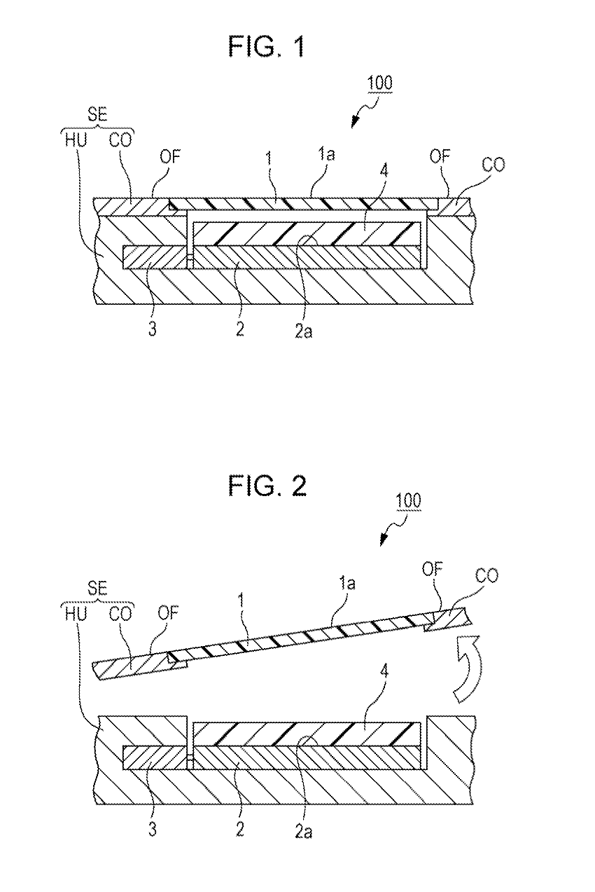

First, the configuration of the electrostatic capacitive input device 100 according to the embodiment will be described with reference to FIG. 1. FIG. 1 is a diagram showing the electrostatic capacitive input device 100.

As shown in FIG. 1, the electrostatic capacitive input device 100 includes: an operation member 1 having an operation surface 1a on which an operator can perform an input operation; a sensor member 2 which has a detection surface 2a detecting a capacitance value corresponding to the input operation on the operation surface 1a and which is capable of outputting a detection signal corresponding to the detected capacitance value; a control unit 3 which controls an electronic apparatus SE on the basis of the detection signal; and an overlay member 4 which stabilizes detection accuracy of the sensor member 2.

The operation member 1 is made of a synthetic resin and formed in a plate shape, and has, on one surface thereof, the operation surface 1a which is operated by the operator.

The sensor member 2 is formed in a plate shape and has, on one surface thereof, the detection surface 2a which is capable of detecting a capacitance value. In addition, a plurality of X-axis electrode lines 2b (not shown) and a plurality of Y-axis electrode lines 2c (not shown) are buried within the sensor member 2, a plurality of the X-axis electrode lines 2b are arranged parallel to each other and at equal intervals on a surface parallel to the detection surface 2a, and a plurality of the Y-axis electrode lines 2c are arranged parallel to each other and at equal intervals on a surface which is parallel to the detection surface 2a and different from the surface on which the X-axis electrode lines 2b are arranged. It is noted that the X-axis electrode lines 2b and the Y-axis electrode lines 2c are arranged so as to be orthogonal to each other when been seen in a plan view from the detection surface 2a side. In addition, the sensor member 2 includes an IC (integrated circuit) (not shown) which transmits the detection signal corresponding to the capacitance value detected by the detection surface 2a.

The control unit 3 includes an IC (not shown) which controls the electronic apparatus SE, on which the electrostatic capacitive input device 100 is mounted, on the basis of the detection signal transmitted by the sensor member 2.

The overlay member 4 is made of a synthetic resin material and formed in a plate shape having a uniform thickness dimension.

Next, the structure of the electrostatic capacitive input device 100 will be described with reference to FIGS. 1 and 2. FIG. 2 is a diagram showing a state where a cover member CO of the electronic apparatus SE is separated from a housing HU of the electronic apparatus SE.

In the electrostatic capacitive input device 100, the operation member 1 and the sensor member 2 are arranged such that a surface reverse to the surface including the operation surface 1a of the operation member 1 faces the detection surface 2a of the sensor member 2. In addition, the operation member 1 is separable from the sensor member 2 without impairing the function of the sensor member 2 (without cutting electrical connection between the sensor member 2 and the electronic apparatus SE).

The overlay member 4 is provided so as to be laminated on the detection surface 2a of the sensor member 2 and is retained by a pressure sensitive adhesive tape or the like. In addition, at that time, the overlay member 4 and the operation member 1 are separated from each other.

In addition, the control unit 3 is arranged so as to be aligned with the sensor member 2, and the sensor member 2 and the control unit 3 are connected to each other such that the detection signal can be communicated therebetween.

It is noted that the electrostatic capacitive input device 100 is mounted and used on the electronic apparatus SE in which the housing HU and the cover member CO are separable from each other. At that time, the operation member 1 is mounted on the cover member CO such that the operation surface 1a is exposed from an outer surface OF of the cover member CO of the electronic apparatus SE, and the sensor member 2 is arranged in the housing HU in a state of being separated from the operation member 1. In addition, as shown in FIG. 2, the operation member 1 is separable from the sensor member 2 together with the cover member CO, and the control unit 3 is arranged in the housing HU together with the sensor member 2.

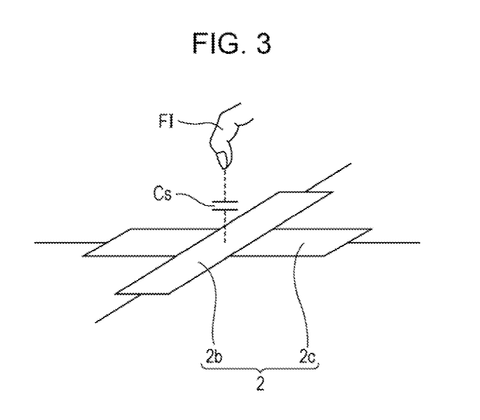

Next, an operation of the electrostatic capacitive input device 100 will be described with reference to FIG. 3. FIG. 3 is a conceptual diagram showing a capacitance generated when an operation body FI comes close to the sensor member 2. In FIG. 3, for easy understanding of explanation, only the operation body FI and a pair of the X-axis electrode line 2b and the Y-axis electrode line 2c buried within the sensor member 2 are shown. It is noted that either when the operation body FI such as a finger tip of the operator comes close to the operation surface 1a, or when the operation body FI touches the operation surface 1a, the same operation is performed. Thus, the case where the operation body FI or the like comes close to the operation surface 1a will be described below.

When the operation surface 1a is operated, the electrostatic capacitive input device 100 detects the operated position on the operation surface 1a as data regarding two different coordinate axes, for example, data of an X coordinate and a Y coordinate, and controls the electronic apparatus SE (performs an input with respect to the electronic apparatus SE) on the basis of the detection result. In the following, an operation in the case where the operation body FI comes close to the X-axis electrode line 2b which is a detection electrode will be described on the assumption that an X coordinate position on the operation surface 1a which is operated by the operation body FI is detected and then a Y coordinate position thereof is detected.

When the operation body FI comes close to the X-axis electrode line 2b through the operation member 1, the overlay member 4, and the sensor member 2, a capacitance Cs is generated between the operation body FI and the X-axis electrode line 2b as shown in FIG. 3. In other words, the operation body FI and the X-axis electrode line 2b are capacitively coupled with each other to provide a state of being earthed to the human body via the operation body FI. Thus, a current flows from the X-axis electrode line 2b to the operation body H via the capacitance Cs. The IC of the sensor member 2 detects an amount of voltage drop by the influence of the current, thereby detecting that the operation body FI comes close. In addition, after the X coordinate position is detected, similar detection is performed for the Y-axis electrode line 2c to detect a Y axis coordinate position, whereby the coordinate of the position on the operation surface 1a operated by the operation body FI can be obtained.

It is noted that the capacitive coupling between the operation body FI and the X-axis electrode line 2b becomes denser as the operation body H comes close to the sensor member 2, and becomes sparser as the operation body FI moves away from the sensor member 2. The denser the capacitive coupling is, the higher the detection sensitivity is. The sparser the capacitive coupling is, the lower the detection sensitivity is.

As described above, the sensor member 2 transmits the detected coordinate data (detection signal) to the control unit 3, and the control unit 3 analyses the detection signal and performs control with respect to the electronic apparatus SE, such as moving a cursor rightward, according to the result.

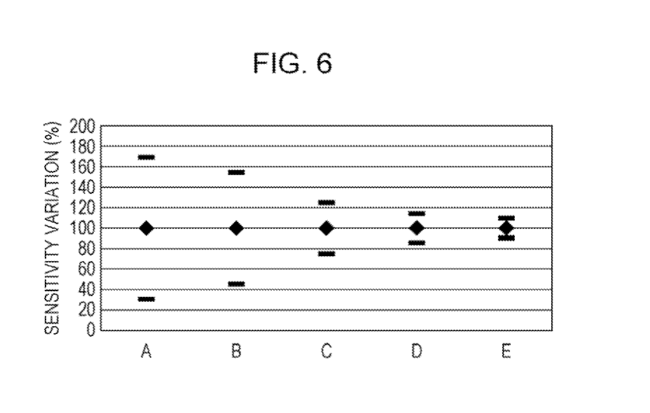

Next, a result of a verification experiment for confirming variation of output in the case where the separation distance w (mm) between the overlay member 4 and the operation member 1 is fixed as 0.1 (mm) and the thickness dimension t (mm) of the overlay member 4 is changed will be described with reference to FIG. 6. FIG. 6 is a graph showing difference in variation of output by difference in the thickness dimension t of the overlay member 4, and indicates that outputs are different between “−” marks in the graph per experiment condition. It is noted that in each experiment condition, the thickness dimension t of the overlay member 4 is set to a dimension as shown in Table 1. In addition, the case (experiment condition A) where there is no overlay member 4 was also confirmed.

TABLE 1

| Experiment | | |
|---|---|---|
| condition | t | w |
| A | None | 0.1 mm |
| B | 0.3 mm | 0.1 mm |
| C | 0.5 mm | 0.1 mm |
| D | 0.8 mm | 0.1 mm |
| E | 1.0 mm | 0.1 mm |

From the graph shown in FIG. 6, it is recognized that when the separation distance w between the overlay member 4 and the operation member 1 is fixed as 0.1 (mm), variation of output is smaller in an experiment condition where the thickness dimension t of the overlay member 4 is large, than in an experiment condition where the thickness dimension t of the overlay member 4 is small. Therefore, the thickness dimension t of the overlay member 4 upon implementation is desirably approximated to the dimension in an experiment condition D (t=0.8 mm) or an experiment condition E (t=1.0 mm) in Table 1. In addition, there is variation of output between the experiment condition D and the experiment condition E in Table 1, but the variation of output can be said to be such an extent that the sensitivity is not too high and an operation is easily performed.

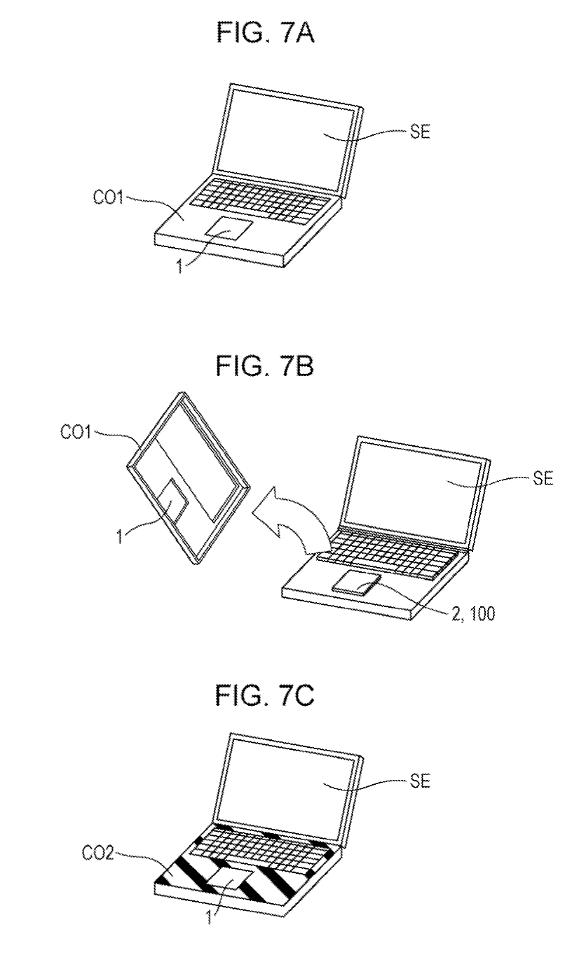

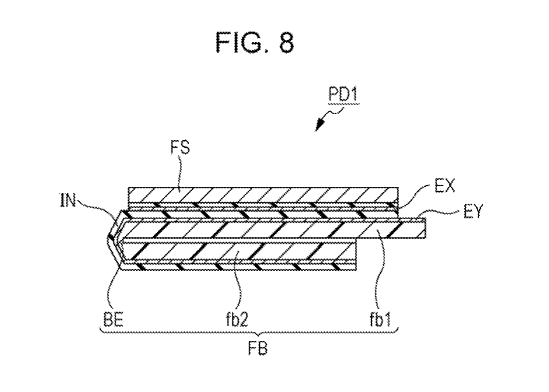

Hereinafter, the advantageous effects of the embodiment will be described with reference to FIGS. 2 and 7A to 7C. FIGS. 7A to 7C are diagrams showing a state the cover member CO is replaced with a cover member CO2 of a different design, FIG. 7A is a diagram showing an initial state of the electronic apparatus SE, FIG. 7B is a diagram showing a state where the cover member CO is being replaced, and FIG. 7C is a diagram showing the electronic apparatus SE in a state of having been replaced with the cover member CO2 of the different design.

The electrostatic capacitive input device 100 according to the embodiment is mounted on the electronic apparatus SE in which the housing HU and the cover member CO are separable from each other, and includes: the operation member 1 having the operation surface 1a on which the operator can perform an input operation; the sensor member 2 which has the detection surface 2a detecting a capacitance value corresponding to the input operation on the operation surface 1a and is capable of outputting a detection signal corresponding to the detected capacitance value; and the control unit 3 which controls the electronic apparatus SE on the basis of the detection signal. In the electrostatic capacitive input device 100 in which the operation member 1 and the sensor member 2 are arranged such that the surface reverse to the surface including the operation surface 1a faces the detection surface 2a, the operation member 1 is mounted on the cover member CO such that the operation surface 1a is exposed from the outer surface OF of the cover member CO of the electronic apparatus SE, and the sensor member 2 is arranged in the housing HU in a state of being separated from the operation member 1. The operation member 1 is separable from the sensor member 2together with the cover member CO.

Thus, since the operation member 1 is separable from the sensor member 2 together with the cover member CO of the electronic apparatus SE as shown in FIG. 2, it is possible for the user to remove the cover member CO together with the operation member 1 without impairing the function of the electrostatic capacitive input device 100 (the sensor member 2) after the electrostatic capacitive input device 100 is incorporated into the electronic apparatus SE. Therefore, the user of the electronic apparatus SE can separate a cover member CO1 which is originally mounted on the electronic apparatus SE and designed as shown in FIG. 7A, from the housing HU with the operation member 1 retained therein, as shown in FIG. 7B. Furthermore, as shown in FIG. 7C, for example, the cover member CO1 can be replaced with a cover member CO2 of a favorite design on which another operation member 1 is mounted. As described above, an effect is provided that an electrostatic capacitive input device can be provided which makes it possible for the user to replace the cover member CO1 of the electronic apparatus SE by themselves without impairing the function of the electrostatic capacitive input device 100 (the sensor member 2).

In addition, thus, since the surface reverse to the surface including the operation surface 1a is separated from the detection surface 2a, capacitive coupling in the operation surface 1a is not dense as compared to the case where the surface reverse to the surface including the operation surface 1a is in close contact with the detection surface 2a, and thus an effect is provided that a change amount of the capacitance value at an input operation is not too large, there is no exaggerated response, and an input operation is easily performed.

In addition, when the surface reverse to the surface including the operation surface 1a is in close contact with the detection surface 2a, occurrence of a detection error by a pressing force being applied to the sensor member 2 through an input operation is considered. However, since the surface reverse to the surface including the operation surface 1a is separated from the detection surface 2a to provide a space where the operation member 1 bends, an effect is provided that a pressing force by an input operation is not transmitted to the sensor member 2 and an input operation can be performed with higher accuracy.

In addition, in the electrostatic capacitive input device 100 according to the embodiment, the sensor member 2 includes the overlay member 4 provided so as to be laminated on the detection surface 2a, and the overlay member 4 and the operation member 1 are separated from each other.

Thus, the capacitance value is likely to vary in a layer of air due to influence from the outside. However, since the overlay member 4 is arranged so as to be laminated on the detection surface 2a, a layer of air between the operation member 1 and the detection surface 2a is small, and the capacitance value is unlikely to be influenced within the overlay member 4 by the outside. Thus, an effect is provided that variation of the capacitance value due to influence from the outside is small and a more stable input operation is possible.

In addition, thus, since the layer of air is provided between the operation member 1 and the detection surface 2a, an effect is provided that a pressing force by an input operation is not transmitted to the sensor member 2 and an input operation can be performed with higher accuracy.

In addition, in the electrostatic capacitive input device 100 according to the embodiment, the thickness dimension of the overlay member 4 is made uniform.

Thus, since the thickness dimension of the overlay member 4 is made uniform, an effect is provided that variation of the thickness dimension of a layer of air between the operation member 1 and the overlay member 4 due to difference in an operation position is small and a more stable input operation is possible.

### Second Embodiment

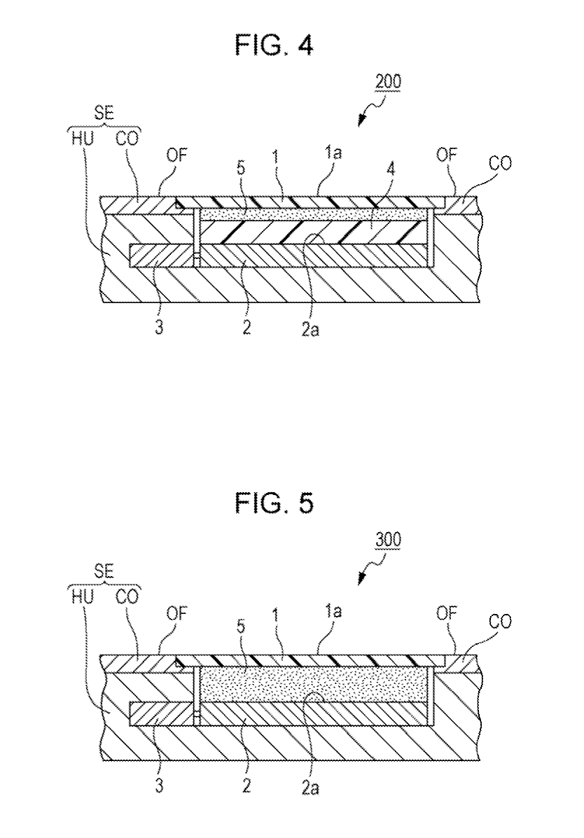

Hereinafter, an electrostatic capacitive input device 200 according to a second embodiment will be described with reference to FIG. 4. FIG. 4 is a diagram showing the electrostatic capacitive input device 200 according to the second embodiment. It is noted that components common with those of the electrostatic capacitive input device 100 according to the first embodiment are designated by the same reference characters as those used in the electrostatic capacitive input device 100, and the detailed description thereof is omitted.

As shown in FIG. 4, the electrostatic capacitive input device 200 includes: an operation member 1 having an operation surface 1 a on which an operator can perform an input operation; a sensor member 2 which has a detection surface 2a detecting a capacitance value corresponding to the input operation on the operation surface 1a and is capable of outputting a detection signal corresponding to the detected capacitance value; a control unit 3 which controls an electronic apparatus SE on the basis of the detection signal; an overlay member 4 which stabilizes detection accuracy of the sensor member 2; and a flexible member 5 having flexibility.

As shown in FIG. 4, the flexible member 5 is made of a gel-like material such as silicon, and is formed in a sheet shape having flexibility and adhesiveness.

As shown in FIG. 4, in the electrostatic capacitive input device 200, the operation member 1 and the sensor member 2 are arranged such that a surface reverse to a surface including the operation surface 1a of the operation member 1 faces the detection surface 2a of the sensor member 2. In addition, the operation member 1 is separable from the sensor member 2 without impairing the function of the sensor member 2 (without cutting electrical connection between the sensor member 2 and the electronic apparatus SE).

The overlay member 4 is provided so as to be laminated on the detection surface 2a of the sensor member 2 and so as to be separated from the operation member 1, and is retained by a pressure sensitive adhesive tape or the like.

The flexible member 5 is arranged between the overlay member 4 and the operation member 1. The flexible member 5 is in contact with the overlay member 4 and the operation member 1, and is retained by an adhesive force of the flexible member 5. It is noted that the flexible member 5 can easily be peeled off from the overlay member 4 and the operation member 1.

In addition, the control unit 3 is arranged so as to be aligned with the sensor member 2, and the sensor member 2 and the control unit 3 are connected to each other such that the detection signal can be communicated therebetween.

It is noted that similarly to the electrostatic capacitive input device 100, the electrostatic capacitive input device 200 is mounted and used on the electronic apparatus SE in which a housing HU and a cover member CO are separable from each other.

Hereinafter, the advantageous effects of the embodiment will be described.

In the electrostatic capacitive input device 200 according to the embodiment, the flexible member 5 having flexibility is arranged between the overlay member 4 and the operation member 1, and the flexible member 5 is in contact with the overlay member 4 and the operation member 1.

Thus, since the flexible member 5 having flexibility is arranged between the overlay member 4 and the operation member 1 so as to be in contact with the overlay member 4 and the operation member 1, there is no layer of air between the overlay member 4 and the operation member 1. In addition, when a pressing force by an input operation is transmitted to the sensor member 2, occurrence of a detection error due to the influence of the pressing force is considered. However, the flexible member 5 deforms to follow bending or the like of the operation member 1 by an input operation, and thus an excessive pressing force is not transmitted to the sensor member 2. Therefore, an effect is provided that the operability is not deteriorated and a more stable input operation is possible.

In addition, in the electrostatic capacitive input device 200 according to the embodiment, the flexible member 5 is formed from a gel-like material.

Thus, since the flexible member 5 is formed from a gel-like material, the flexible member 5 has adhesiveness. Due to the adhesiveness, the flexible member 5 is retained and can easily be peeled off. Thus, an effect is provided that separation of the operation member 1 is not disturbed.

### Third Embodiment

Hereinafter, an electrostatic capacitive input device 300 according to a third embodiment will be described with reference to FIG. 5. FIG. 5 is a diagram showing the electrostatic capacitive input device 300 according to the third embodiment. It is noted that components common with those of the electrostatic capacitive input device 100 according to the first embodiment or those of the electrostatic capacitive input device 200 according to the second embodiment are designated by the same reference characters used in the electrostatic capacitive input device 100 or the electrostatic capacitive input device 200, and the detailed description thereof is omitted.

As shown in FIG. 5, the electrostatic capacitive input device 300 includes: an operation member 1 having an operation surface 1 a on which an operator can perform an input operation; a sensor member 2 which has a detection surface 2a detecting a capacitance value corresponding to the input operation on the operation surface 1a and is capable of outputting a detection signal corresponding to the detected capacitance value; a control unit 3 which controls an electronic apparatus SE on the basis of the detection signal; and a flexible member 5 having flexibility.

As shown in FIG. 5, in the electrostatic capacitive input device 300, the operation member 1 and the sensor member 2 are arranged such that a surface reverse to a surface including the operation surface 1a of the operation member 1 faces the detection surface 2a of the sensor member 2. In addition, the operation member 1 is separable from the sensor member 2 without impairing the function of the sensor member 2 (without cutting electrical connection between the sensor member 2 and the electronic apparatus SE).

The flexible member 5 is arranged between the sensor member 2 and the operation member 1. The flexible member 5 is in contact with the sensor member 2 and the operation member 1 and is retained by an adhesive force of the flexible member 5. It is noted that the flexible member 5 can easily be peeled off from the sensor member 2 and the operation member 1.

In addition, the control unit 3 is arranged so as to be aligned with the sensor member 2, and the sensor member 2 and the control unit 3 are connected to each other such that the detection signal can be communicated therebetween.

It is noted that similarly to the electrostatic capacitive input device 100 and the electrostatic capacitive input device 200, the electrostatic capacitive input device 300 is mounted and used on the electronic apparatus SE in which a housing HU and a cover member CO are separable from each other.

Hereinafter, the advantageous effects of the embodiment will be described.

In the electrostatic capacitive input device 300 according to the embodiment, the flexible member 5 having flexibility is arranged between the sensor member 2 and the operation member 1, and the flexible member 5 is in contact with the sensor member 2 and the operation member 1.

Thus, since the flexible member 5 is arranged between the sensor member 2 and the operation member 1 so as to be in contact with the sensor member 2 and the operation member 1, there is no layer of air between the sensor member 2 and the operation member 1. In addition, when a pressing force by an input operation is transmitted to the sensor member 2, occurrence of a detection error due to the influence of the pressing force is considered. However, the flexible member 5 deforms to follow bending or the like of the operation member 1 by an input operation. Therefore, an effect is provided that the operability is not deteriorated and a more stable input operation is possible.

Although the electrostatic capacitive input devices according to the embodiments of the present invention have been specifically described above, the present invention is not limited to the above-described embodiments, various modifications can be made without departing from the gist of the present invention, to implement the present invention. For example, the following modifications can be made to implement the present invention, and these embodiments also belong to the technical scope of the present invention.

(1) In each embodiment, the X-axis electrode lines 2b and the Y-axis electrode lines 2c are orthogonal to each other when been seen in a plan view, but may not be necessarily perpendicular to each other as long as they intercross each other.

(2) In each embodiment, the X-axis electrode lines 2b and the Y-axis electrode lines 2c are buried within the sensor member 2, but may be formed directly on the sensor member 2 by printing, or may be formed independently of the sensor member 2.

(3) In each embodiment, the control unit 3 is arranged so as to be aligned with the sensor member 2, but may be arranged so as to overlap the sensor member 2, or the sensor member 2 and the control unit 3 may be formed so as to be integrated with each other.

(4) In each embodiment, the electrostatic capacitive input device is mounted on the electronic apparatus SE in which the cover member CO and the housing HU are separable from each other, but may be mounted and used on an electronic apparatus in which a cover member CO and a housing HU are not separable from each other.

1. An electrostatic capacitive input device mounted on an electronic apparatus including a housing and a cover member covering the housing, the electrostatic capacitive input device comprising:
an operation member mounted on the cover member, the operation member having an operation surface on which an input operation is performed by an operator, the operation surface being exposed on an outer surface of the cover member;
a sensor member arranged in the housing, the sensor member being separated from the operation member and having a detection surface facing a reverse surface of the operation member opposite to the operation surface, the detection surface being configured to detect a capacitance value corresponding to the input operation on the operation surface, the sensor member outputting a detection signal corresponding to the detected capacitance value; and
a control unit configured to control the electronic apparatus on the basis of the detection signal,
wherein
the operation member, together with the cover member, is separable from the sensor member.

2. The electrostatic capacitive input device according to claim 1, wherein
the sensor member includes an overlay member laminated on the detection surface, and
the overlay member and the operation member are separated from each other.

3. The electrostatic capacitive input device according to claim 2, further comprising a flexible member provided between the overlay member and the operation member, the flexible member being in contact with the overlay member and the operation member.

4. The electrostatic capacitive input device according to claim 1, further comprising a flexible member provided between the sensor member and the operation member, the flexible member being in contact with the sensor member and the operation member.

5. The electrostatic capacitive input device according to claim 2, wherein the overlay member has a uniform thickness.

6. The electrostatic capacitive input device according to claim 3, wherein the flexible member is formed of a gel-like material.
